(19) United States
(12) Patent Application Publication
(10) Pub. No.: US 2005/0110801 A1
(43) Pub. Date: May 26, 2005

(54) Methods and systems for processing displayed images

(76) Inventor: I-Jong Lin, Rolling Hill Estate, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/718,151

(22) Filed: Nov. 20, 2003

(51) Int. Cl. G06K 9/68

(52) U.S. Cl. 345/620; 345/634

(57) ABSTRACT

Systems and methods according to the present invention describe image processing techniques for processing images wherein a displayed image is potentially occluded. The occluding object can then itself be displayed on the video device. Passive and active testing techniques resolve ambiguity between the occluding object and the displayed image.

### BACKGROUND

The present invention relates generally to display systems and, more particularly, to display systems and methods for displaying objects which occlude a display.

Today, presentations are commonly made using computer-controlled displays. In some cases, the presenter will stand in front of the display and provide a commentary while pointing to various features on the display. For example, weather forecasters are routinely seen standing in front of a map having weather symbols displayed thereon. By using a computer generated background, the map and/or weather symbols can be easily changed to track the weather forecaster's commentary. The composite video of the weather forecaster and the displayed map is typically generated using a technique known as chromakey. As shown in FIG. 1, the chromakey technique involves, for example, providing a background screen 10 behind the weather forecaster having a predetermined color, e.g., blue or green. An image capture device 12 captures images of both the weather forecaster and the background screen. These images are transferred to processor 14, wherein the portion of the image having the predetermined color is removed and replaced by the weather map with symbols, while leaving intact the portion of the image which shows the weather forecaster. The composite image of the weather forecaster and the weather map are then displayed on a display 16 for reference by the weather forecaster, as well as being broadcast as the desired video image. The display 16 is, therefore, out of the line of sight of image capture device 12.

Chromakey techniques are generally included within the category of image segmentation techniques. Other video segmentation techniques include those which involve using a reference image to perform the segmentation and using other a priori knowledge of the portion of the image to be segmented, e.g., in intruder detections systems.

### SUMMARY

Systems and methods according to exemplary embodiments of the present invention provide techniques for displaying an occlusion of a display on the display including the steps of generating an image to the display, capturing first contents of the display with an image capture device, the image capture device being spaced from the display, analyzing the first contents to identify a first set of potentially occluded pixels, changing a value of the first set of potentially occluded pixels on the display, capturing second contents of the display with the image capture device, selectively confirming the first set potentially occluded pixels as confirmed occluded pixels based on the second contents and generating the confirmed occluded pixels on the display using a predetermined display value.

According to other exemplary embodiments of the present invention, methods for processing a displayed image perform the steps of passively testing a version of the displayed image captured by an image capture device to determine if a portion of the displayed image is blocked from the image capture device and actively testing the portion of the displayed image to confirm whether the portion of the displayed image is blocked from the image capture device.

According to another exemplary embodiment of the present invention, an image processing system includes a display for displaying the image, an image capture device for capturing a version of the displayed image and a processor, connected to the display and the image capture device for passively testing the version of the displayed image captured by the image capture device to determine if a portion of the displayed image is blocked from the image capture device; and for actively testing the portion of the displayed image to confirm whether the portion of the displayed image is blocked from the image capture device.

### BRIEF DESCRIPTION OF THE DRAWINGS

The accompanying drawings illustrate exemplary embodiments of the present invention, wherein:

FIG. 1 depicts a known chromakey technique;

FIG. 2 shows a system for image processing according to exemplary embodiments of the present invention;

FIGS. 3(a)-3(c) depict state diagrams associated with image processing techniques according to exemplary embodiments of the present invention;

FIGS. 4(a) and 4(b) are flow diagrams depicting image processing methods according to exemplary embodiments of the present invention;

FIGS. 5(a) and 5(b) illustrate outputs of image processing techniques according to exemplary embodiments of the present invention;

FIGS. 6(a)-6(c) depict display pixel values, image capture device pixel values and state pixel values, respectively, used to describe a first iteration of an image processing technique according to exemplary embodiment of the present invention;

FIGS. 7(a)-7(c) depict display pixel values, image capture device pixel values and state pixel values, respectively, used to describe a second iteration of the image processing technique described with respect to FIGS. 6(a)-6(c);

FIGS. 8(a)-8(c) depict display pixel values, image capture device pixel values and state pixel values, respectively, used to describe a third iteration of the image processing technique described with respect to FIGS. 6(a)-6(c);

FIGS. 9(a)-9(c) depict display pixel values, image capture device pixel values and state pixel values, respectively, used to describe a first iteration of an image processing technique according to exemplary embodiment of the present invention;

FIGS. 10(a)-10(c) depict display pixel values, image capture device pixel values and state pixel values, respectively, used to describe a second iteration of the image processing technique described with respect to FIGS. 9(a)-9(c);

FIGS. 11(a)-11(c) depict display pixel values, image capture device pixel values and state pixel values, respectively, used to describe a third iteration of the image processing technique described with respect to FIGS. 9(a)-9(c);

FIGS. 12(a)-12(c) depict display pixel values, image capture device pixel values and state pixel values, respectively, used to describe a fourth iteration of the image processing technique described with respect to FIGS. 9(a)-9(c); and

FIG. 13 shows an exemplary state diagram associated with image processing techniques and systems according to another exemplary embodiment of the present invention.

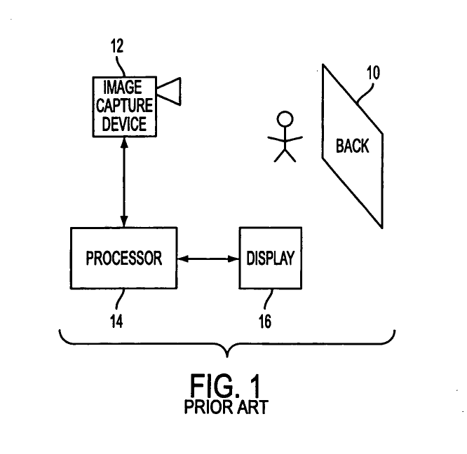

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

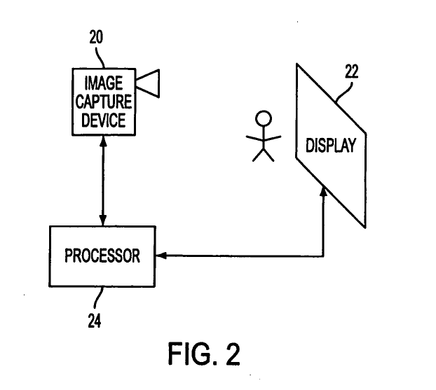

In order to provide some context for this discussion, an image processing system according to an exemplary embodiment of the present invention will first be described with respect to FIG. 2. Therein, an image capture device 20, e.g., a camera, a digital or analog video device, etc., captures images which are displayed on a display 22, which may be occluded by a person or object interposed between the image capture device 20 and the display 22. The image capture device 20 may be any type of digital image capture device and the display can be a any type of display including a projector. The images are then passed to processor 24, e.g., a personal or other computer, for processing in accordance with the present invention. This processing involves controlling both the image capture device 20 and the display 22 to cast a virtual shadow of any object(s) which are blocking the image capture device's view of the display. This is accomplished, according to exemplary embodiments of the present invention, by using both an active and a passive testing technique. The passive technique estimates the image rendered on the display 22 and uses this estimate to determine whether individual pixels are being occluded, without manipulating the display 22. The active technique changes pixels on the display 22 to a known color and then the processor 24 observes changes (or lack thereof) in the images subsequently captured by the image capture device 20. Thus, according to exemplary embodiments of the present invention, the passive technique can be used to identify pixels which are potentially occluded and then, using these pixels as seed areas, the active technique tests and grows these regions outwardly until the occlusion's boundaries are discovered.

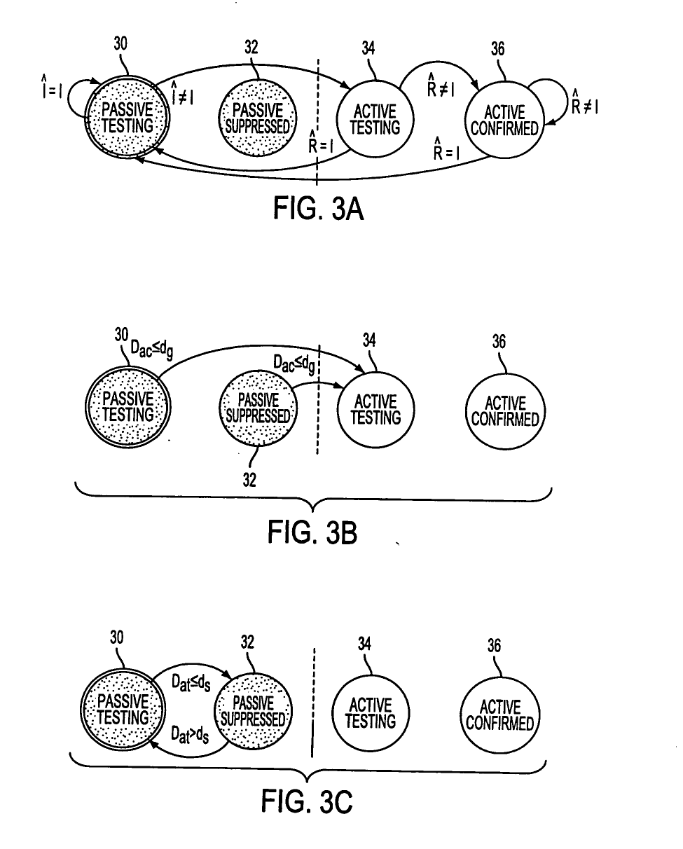

A set of exemplary state diagrams which can be used to conceptually describe the passive and active techniques employed by exemplary embodiments of the present invention are shown in FIGS. 3(a)-3(c). Therein, four exemplary states are shown: a passive testing state 30, a passive suppressed state 32, an active testing state 34 and an active confirmed state 36. Each pixel used to capture the images by image capture device 20 will be associated with one of these four states at any given time during processing. Pixels in the passive testing state 30 have corresponding pixels on the display 22 which have a value associated with the image rendered on the display 22. At the start of processing all image capture device pixels start in the passive testing state 30, i.e., at start-up of the processing it is assumed that there is no occlusion of the display 22. Pixels in the passive suppressed state 32 are considered to be in a mixed or unknown state relative to corresponding pixels on the display 22. The passive suppressed state 32 is used to compensate for the influences of the active testing technique, as will be described in more detail below. Pixels in the active testing state 34 have corresponding pixels on the display 22 which have a value reserved for active testing. Note that pixels will not stay in this state, but will either transition to the active confirmed state 36 or the passive testing state 30. Pixels in the active confirmed state have corresponding pixels on the display 22 which have a value reserved for active testing, but cannot be seen by the image capture device pixels due to an occlusion.

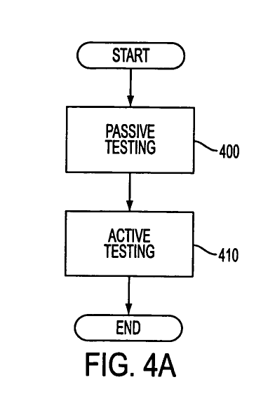

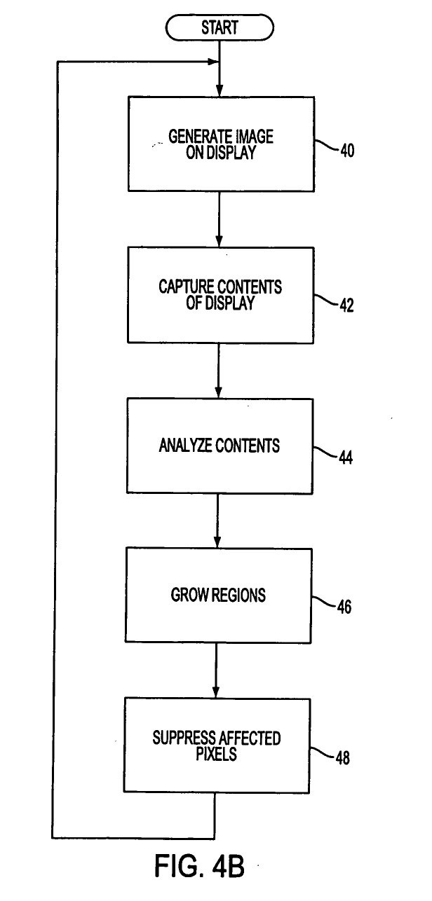

An exemplary image processing technique according to the present invention will now be described with respect to the flow diagrams of FIG. 4(a) and 4(b) as well as the state diagrams of FIGS. 3(a)-3(c). Referring first to the flow diagram of FIG. 4(a), a general method for image processing according to an exemplary embodiment of the present invention involves a passive testing step 400, wherein captured pixel values are compared with expected values, and an active testing step 410, wherein portions (or all of) the display are driven with a reserved value and the results are analyzed. Steps 400 and 410 can be performed sequentially or in parallel. A more detailed exemplary image processing method is shown in FIG. 4(b). Therein, at step 40, an image is generated to display 22. At the first iteration all of the display pixels have a value associated with the image, however during subsequent iterations step 40 involves generating those pixels in the active testing state 34 and active confirmed state 36 using a reserved value and generating those pixels in the passive testing state 30 and passive suppressed state 32 with the image values. The contents of the display 22 are then captured by the image capture device 20 at step 42. If nothing is blocking the line of sight path between the image capture device 20 and the display 22, then the captured contents should match the image on the display. If, on the other hand, there is an object occluding the displayed image, then the captured contents may have some disparity relative to the displayed image.

At step 44 processor 24 performs a first pass analysis of the captured contents. This involves a pixel-by-pixel analysis of the captured contents relative to corresponding pixels on the display 22 and selective state transitions based on that analysis. Herein, the use of the term “value” as it refers to pixels can mean any visible characteristic, or combination of visible characteristic, of a displayed pixel including, for example, a color value or an intensity value.

Referring now to FIG. 3(a), an image capture device pixel currently in the passive testing state 30 has an actual value (I), e.g., a value captured by the image capture device at a given time. If the actual value I is the same as the expected value (Î), which expected value is based on the assumption that that pixel captured a corresponding portion of the displayed image, then that image capture device pixel remains in the passive testing state 30. Alternatively, if an image capture device pixel in the passive testing state 30 has an actual value I which differs from the expected value Î of that pixel, then that image capture device pixel will be transitioned at step 44 from the passive testing state 30 to the active testing state 34 since it is a potentially occluded image capture device pixel. For pixels which are already in the active testing state at step 44, the processor 24 will drive the corresponding portions of the display 22 using the display value reserved for active testing. Thus, the captured contents are also analyzed at step 44 to see if those image capture device pixels in the active testing state have the reserved value ( [symbol] ) which is expected if those image capture device pixels are not blocked from the display 22. If so, then the pixel is returned to the passive testing state 30, otherwise the pixel moves to the active confirmed state 36. For image capture device pixels in the active confirmed state 36 at step 44, the same approach is followed, i.e., the processor 24 will drive the corresponding portions of the display using the display value reserved for active testing. If image capture device pixels in the active confirmed state 36 have the reserved value [symbol] , then those pixels are returned to the passive testing state 30. Otherwise, they remain in the active confirmed state 36.

Once the analysis step 44 has been completed for all of the image capture device pixels, the process then moves on to step 46, wherein regions are grown out around active confirmed pixels. This step enables image processing techniques and systems to resolve ambiguities between occlusions and the images displayed on display 22 as will be better appreciated upon a review of the examples provided below. For example, it is possible that the image displayed on display 22 may, in some areas, have the same value (e.g., color) as the value of the occluding object. In such a case, the passive testing process will fail to confirm the corresponding image capture device pixels as being occluded. Thus, step 46 provides an additional mechanism to transition pixels to the active testing state 34. As seen in FIG. 3(b), this step involves transitioning image capture device pixels from either the passive testing state 30 or the passive suppressed state 32 if they are within a predetermined growth distance d_{g} of an active confirmed pixel, i.e., if the distance of a given pixel from an active confirmed pixel (D_{ac}) is less than or equal to d_{g}. The distance d_{g} can be user-specified or preset. However, those skilled in the art will appreciate that the value which is selected for d_{g} will impact the number of iterations which are needed to segment the occluding object(s) from the image displayed on the display 22, i.e., the larger the value selected for d_{g} the fewer the number of iterations. The d_{g} value also represents the rate of active testing/active confirmed growth across an ambiguous region and, thus, determines the size of the “halo” region around an occluding object rendered on the display 22, e.g., the larger the value selected for d_{g}, the larger the halo region. The halo region refers to a set of display pixels that are not occluded but are generated using the reserved color.

Next, at step 48, pixels are suppressed, or unsuppressed, based on their proximity Dₐₜ to image capture device pixels in the active testing state 34. Specifically, a pixel in the passive testing state 30 is transitioned to the passive suppressed state if its distance Dₐₜ to an image capture device pixel in the active testing state is less than or equal to a suppression distance dₛ. This step provides protection against inadvertently identifying unoccluded pixels as occluded pixels as a side effect of the active testing process. For example, it is possible that, based on factors such as the distance between the image capture device 20 and the display 22, the focusing capabilities of the image capture device 20, image capture device resolution, etc., image capture device pixels proximate to an active testing pixel may receive some spillover of the reserved value being shown on the display 22 for that active testing pixel. Such image capture device pixels can be shielded from transition to the active testing state 34 by transitioning them to the passive suppressed state 32 during such time as they are proximate an active testing pixel. The distance dₛ can be determined by, for example, calibrating the system of FIG. 2 prior to operation. For example, the processor 24 can turn on various pixels on the display 22 using the reserved color and analyze the image capture device pixels to determine which image capture device pixels (if any) have the value of the reserved color to determine the extent of the spillover effect.

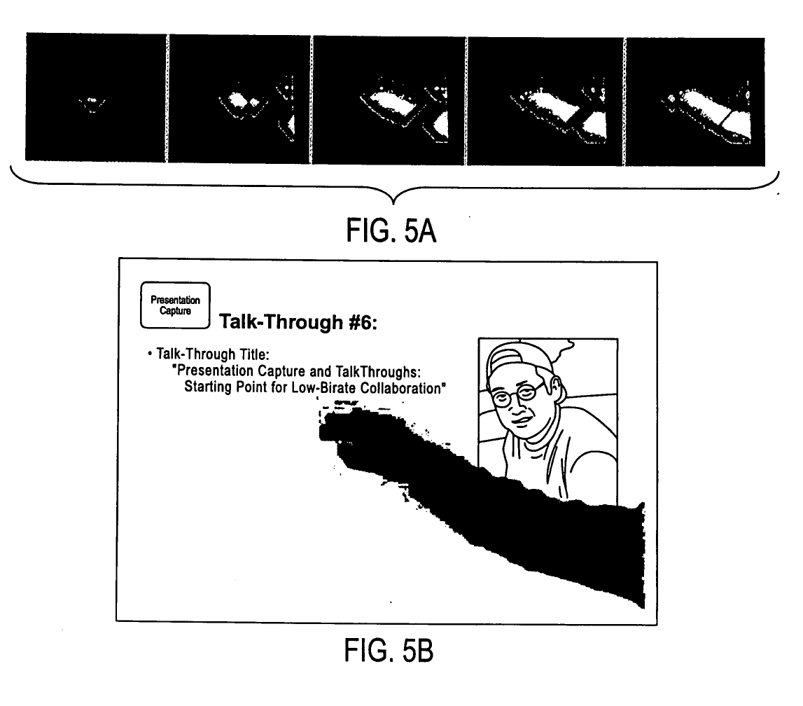

FIG. 5(a) shows how step 46 operates to iteratively grow a shadow around an object which occludes a display. Therein, the white region indicates image capture device pixels which are in the active confirmed state 36. FIG. 5(b) shows an exemplary output of image processing techniques and systems according to the present invention wherein the image of the occluding object is digitally overlaid onto the displayed image, in this case a presentation slide.

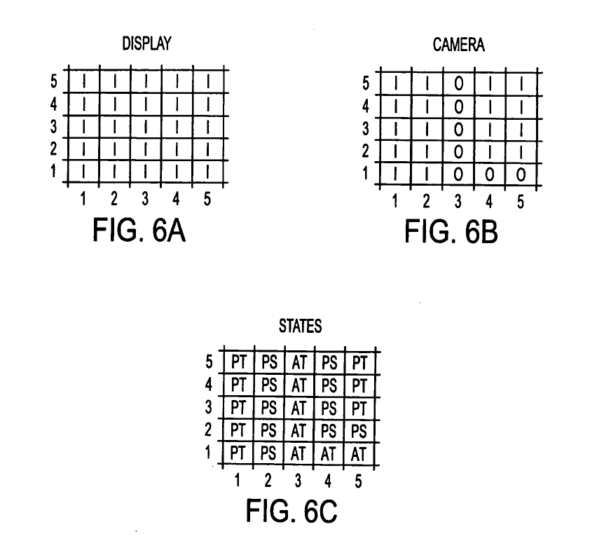

In order to provide an even better understanding of image processing techniques and systems according to the present invention, an exemplary application of the afore-described techniques will now be provided with respect to FIGS. 6(a)-8(c). In these examples, an occluding object is inserted between the image capture device 20 and display 22, specifically a capital letter “L”. A subset of the display pixels and image capture device pixels are shown in FIGS. 6(a)-8(c), using the convention of (column, row) in numbering the pixels. Note that it is assumed for simplicity of the Figures that pixel mapping between the display and the image capture device, i.e., to correlate specific display pixels with specific image capture device pixels, has already been performed. Therefore, the “display pixel values” are values associated with pixel from the display 20 as they would be seen by the image capture device 22 if there is no occlusion. Thus, initially, in FIG. 6(a), each of the display pixels has a value ‘I” of the displayed image. The image capture device 20 captures the pixels shown in FIG. 6(b). Therein, it can be seen that the image capture device pixels in column 3, as well as pixels (4,1) and (5,1) have a value of ‘O’ since they are occluded by the letter “L”. For a first discussion case, assume that for each pixel, the value ‘I’ and the value ‘O’ are different, e.g., the occluding letter “L” is a solid blue and none of the corresponding image pixels in FIG. 6(a) are blue. Initially all of the image capture device pixels are assigned to the passive testing state 30. During the first iteration of the processes illustrated in FIGS. 4(a) and 4(b), all of the image capture device pixels having a value of ‘O’ transition to the active testing state 34 at step 44. No regions are grown out at step 46, since no image capture device pixels have yet reached the active confirmed state 36 during the first iteration. The pixels within predetermined distance Dₐₜ, e.g., one pixel, of the pixels in the active testing state 34 are transitioned to the passive suppressed state 32 at step 48. These states of the corresponding pixels are shown in FIG. 6(c), wherein PT=passive testing state, PS=passive suppressed state and AT=active testing state.

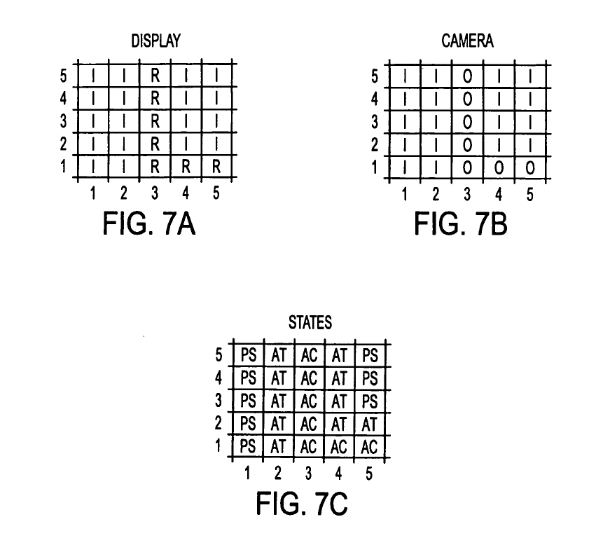

During the second iteration, the display pixels which correspond to the image capture device pixels in the active testing state, i.e., those pixels in column 3, as well as pixels (4,1) and (5,1), are regenerated using the reserved value ‘R’, e.g., white, as shown in FIG. 7(a) at step 40. The remaining display pixels are regenerated using the image value ‘I’. The display contents are again captured at step 42 with the resulting image capture device pixel values shown in FIG. 7(b). Since the actively tested pixels once again have a value different than the expected reserved value, these pixels are transferred to the active confirmed state 35 at step 44. Now, at step 46, those pixels within a predetermined distance d_{g} are also assigned to the active testing state 34 at step 46. Assume, for this example, that d_{g}=1 pixel such that these grown regions include all of the pixels in column 2, as well as pixels (4,2), (4,3), (4,4), (4,5) and (5,2). This results in the pixel state values shown in FIG. 7(c) at the end of the second iteration.

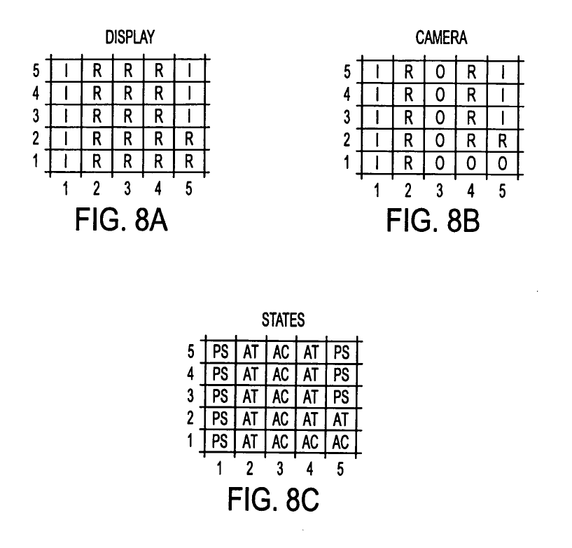

Then, during the third iteration, the display is controlled such that the pixels in the active testing state 34 and active confirmed state.36 have the reserved value ‘R’ as shown in FIG. 8(a), e.g., white, while the remaining pixels are still generated using their respective image values ‘I’. Assuming that no movement of the occlusion occurred between iterations, the captured image capture device pixels have the values shown in FIG. 8(b). The occluded pixels remain in the active confirmed state 36 until the occlusion is removed, during which time they are regenerated using the reserved value. The captured image capture device pixels having the reserved value are returned to the passive testing state 30 and then back to the active testing state 34 since they are still within the growth region. The resulting state values are shown in FIG. 8(c).

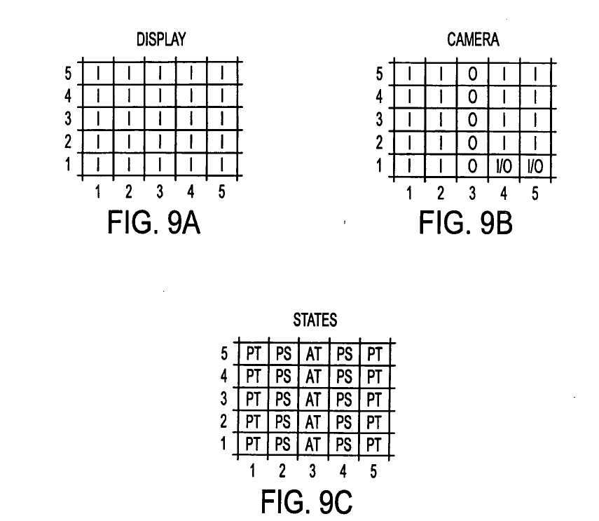

A second case using the same occlusion example highlights some benefits of active testing according to exemplary embodiments of the present invention. Referring now to FIGS. 9(a)-12(c), the display 22 once again displays an image, a pixel subset of which is shown in FIG. 9(a). Once again, an occluding letter ‘L’ is interposed between the image capture device 20 and the display 22. However for this second case the value of the image pixels (4,1) and (5,1) is the same the value of the corresponding pixels of the occluding letter ‘L’, e.g., they are all blue. Thus, in this case the captured image capture device pixels can be represented as shown in FIG. 9(b). As compared with the previous example, for this case step 44 of the exemplary process of FIG. 4 will result in the pixels of column 3 being transferred to the active testing state 34. However, image capture device pixels (4,1) and (5,1) will not be recognized as potentially occluded at step 44 of the first iteration, since their values are the same as the image values of the corresponding display pixels (and, therefore are referred to in the Figures as having a value of “I/O”), and will remain in the passive testing state at step 44. Again, during the first iteration, no image capture device pixels are transferred to the active confirmed state 36 at step 46. Those pixels to either side of column 3 are moved into the passive suppressed state at step 48. The resulting state values at the end of the first iteration are shown in FIG. 9(c).

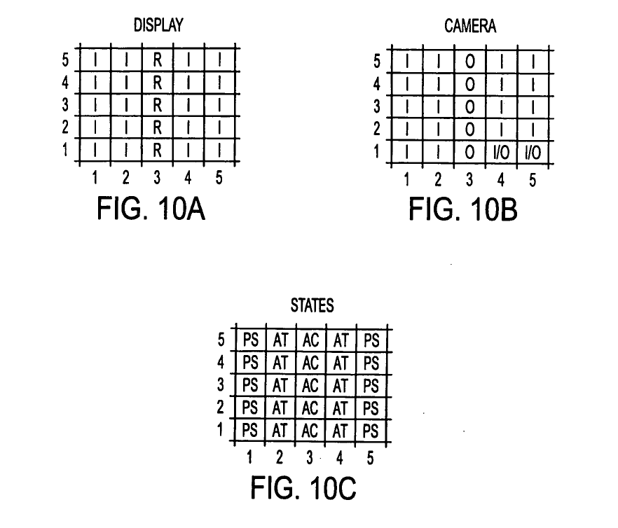

During the second iteration, the display 22 is regenerated as shown in FIG. 10(a), with column 3 being displayed using the reserved value ‘R’. The resulting captured image capture device pixels are shown in FIG. 10(b), thereby confirming that the pixels in column 3 are occluded such that these pixels are transitioned to the active confirmed state 36 during step 44 of the second iteration. Now, the regions proximate to column 3 are grown out by, for example, one pixel at step 46. This results in columns 2 and 4 of the image capture device pixels being added to the active testing state at step 46. The image capture device pixels in columns 1 and 5 will be transitioned to the passive suppressed state at step 48. The resulting pixel states are shown in FIG. 10(c).

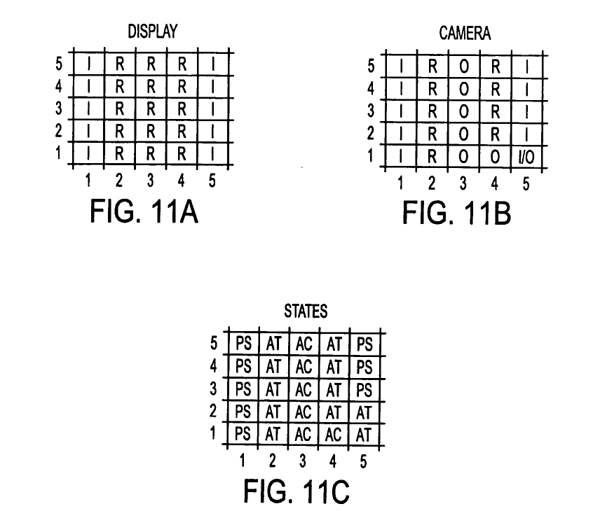

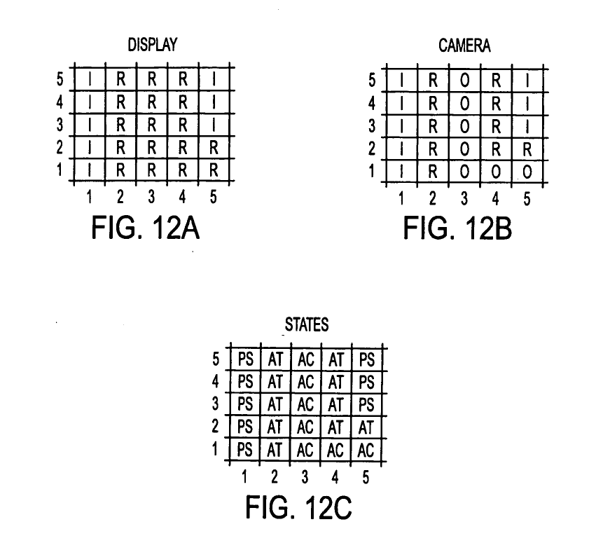

Thus, during the third iteration, the display is regenerated as shown in FIG. 11(a). Assuming again no movement of the occluding letter ‘L’, the captured image capture device pixels are then shown in FIG. 11(b). Of particular interest, note that processor 24 can now identify pixel (4,1) as occluded since the reserved value, e.g., white, is different from the value of the occlusion and image, e.g., blue. The pixel states at the end of the third iteration are shown in FIG. 11(c). During the fourth iteration, pixel (5,1) will be regenerated with the reserved value (FIG. 12(a)) and likewise identified as an occluded pixel (FIG. 12(b)). The pixel state values at the end of the fourth iteration are shown in FIG. 12(c). Thus, the example of FIGS. 9(a)-12(c) illustrate how the growing of regions around active confirmed pixels according to exemplary embodiments of the present invention provides a technique for resolving ambiguity between an occluding object and a displayed image.

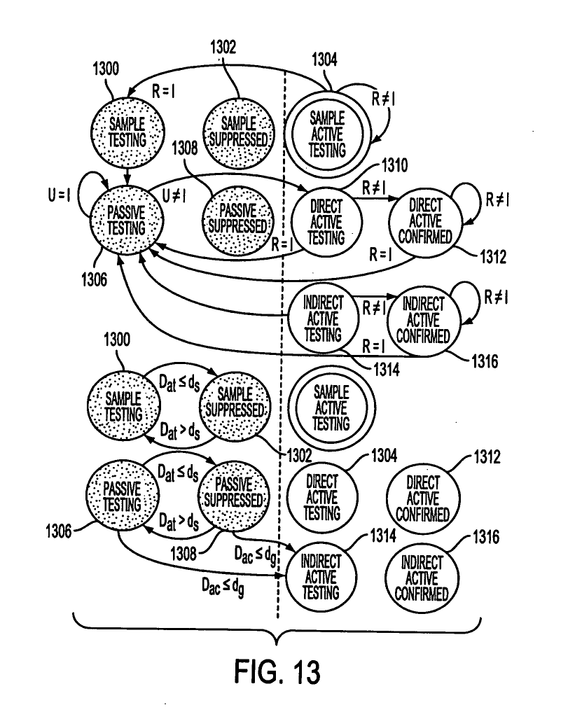

According to another exemplary embodiment of the present invention, additional states can be added to the model of FIGS. 3(a)-3(c) as shown in FIG. 13 which provide for an image processing technique that, among other things, does not initially assume that the image is unoccluded. Accordingly, an active testing step is performed on all image capture device pixels prior to passive testing to provide an appropriate estimate for I. Therein, the sample testing state 1300 is associated with pixels having an uninitialized value for Î. However, pixels in the sample testing state 1300 have also been found to be unoccluded and, on the next transition, image processing techniques and systems according to this exemplary embodiment of the present invention will use the current image capture device pixel value as its first estimate for Î (referred to as ‘U’ in FIG. 13). The sample suppressed state 1302 is also associated with pixels having an uninitialized value for Î. However, a pixel which neighbors a pixel in the sample suppressed state 1302 is in one of the active states, making its image capture device pixel a potentially poor selection as a value to use to initialize its Î. However, once neighbor pixels are moved out of their active states, then a pixel in the sample suppressed state 1302 can move to the sample testing state 1300 and initialization of its Î value. The sample active testing state 1304 is the initial state for all pixels. Its Î value is uninitialized, so the pixel remains in this state until it is unoccluded. Thus, while in the sample testing state 1304, a pixel is generated using to the reserved color on the display 22 and the processor waits until the corresponding image capture device pixel sees the reserved color. Only then, when it seems to be unoccluded, will the process initialize a pixel's Î value by transitioning it to the sample testing state 1300.

The passive testing state 1306 in FIG. 13 is substantially the same as the passive testing state 30 illustrated in FIGS. 3(a)-3(c), except that in this exemplary embodiment the exit conditions for pixels in this state include (1) a difference in those pixels' own image capture device values relative to expected image values (in which case the pixel is transitioned to the direct active testing state 1310) and (2) a proximity to a pixel in an active confirmed state (in which case the pixel is moved to the indirect active testing state 1314. The passive suppressed state 1308 is also substantially the same as the passive suppressed state 32, however the distance calculation which triggers transition to the passive suppressed state 1308 is relative to a pixel in any of the sample, direct or indirect active testing states 1304, 1310 and 1314, respectively. The direct active testing state 1310 is associated with pixels whose contents captured by the image capture device showed something that was not expected by Î. However, if the reserved color is seen by the image capture device for pixels in state 1310 at the next iteration, the image capture device pixel is probably correct and Î is probably incorrect, implying that an update of Î is desirable. However, if pixels in this state 1310 don't see the reserved color on the next iteration, those pixels move to the direct active confirmed state 1312. This state 1312 is substantially similar to the active confirmed state 36 described above with respect to FIGS. 3(a)-3(c). Thus, pixels in this state are considered to be confirmed as occluded and part of a high-quality segmentation. When the image capture device pixels see the reserved color, pixels can move out of this state 1312. Pixels in the indirect active testing state 1314 have transitioned to this state from either the passive testing state 1306 or passive suppressed state 1308 because a neighboring pixel is in either the direct active confirmed state 1312 or the indirect active confirmed state 1315. When pixels in state 1314 see the reserved color in the image capture device, they move back to the passive testing state 1306. If they don't see the reserved color at the next iteration, pixels in the inactive testing state 1314 move to the indirect active confirmed state 1316. Pixels which have transitioned to the indirect active confirmed state provide image processing systems and techniques according to exemplary embodiments of the present invention with certain additional information. First, the pixels have moved into this state as a result of a characteristic of other pixels. Second, these pixels were also occluded, implying that these pixels were probably occluded when they were in the passive testing state 1306. Thus, it may be desirable to update the Î values for these pixels or to change the threshold value used to compare Î with the actual image capture device pixel. In testing image capture device pixels to determine if they are equal to anticipated values, a threshold can be employed to allow for image capture device noise and other effects. If image capture device pixels can express color as one of, for example, 256 color values, then an image capture device pixel value can be said to be “equal” to an anticipated value, e.g., image value estimate or reserved value estimate, if it within a certain range (threshold) of the anticipated value. The particular threshold value can be selected based on various implementation parameters including the value resolution of the image capture device, image capture device noise, etc. According to this exemplary embodiment of the present invention, image processing techniques may vary this threshold value and/or update estimates of the unoccluded image based upon state transitions, e.g., from the direct active testing state 1310 to the passive testing state 1306 or from the indirect active confirmed state 1314 to the passive testing state 1306. For example, if a pixel transitions from the direct active testing state 1310 to the passive testing state 1306, it may be desirable to increase the threshold value since one possible reason for this transition is that the expected value Î for this pixel was incorrectly identified as not being equal to the captured value (I) because the threshold was too low. Conversely, if the pixel transitions from the indirect active confirmed state 1314 to the passive testing state 1306, it may be desirable to reduce the threshold value.

81 Systems and methods for image processing according to exemplary embodiments of the present invention can be performed by one or more processors executing sequences of instructions contained in a memory device (not shown). Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention.

The above-described exemplary embodiments are intended to be illustrative in all respects, rather than restrictive, of the present invention. Thus the present invention is capable of many variations in detailed implementation that can be derived from the description contained herein by a person skilled in the art. Various alternatives are also contemplated by exemplary embodiments of the present invention. For example, the reserved value could be varied over time in order to resolve additional ambiguity, e.g., between the value of the occluding object and the reserved color. Additionally, those display pixels which are occluded need not be repeatedly driven using the reserved value. Instead, the halo region can serve as an outline and the occluded portion of the display can be driven using the image values or remain undriven. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

1. A method for displaying an occlusion of a display on said display comprising the steps of:
generating an image on said display;
capturing first contents of said display with an image capture device, said image capture device being spaced from said display;
analyzing said first contents to identify a first set of potentially occluded pixels;
changing a value of said first set of potentially occluded pixels on said display;
capturing second contents of said display with said image capture device;
selectively confirming said first set potentially occluded pixels as confirmed occluded pixels based on said second contents; and
generating said confirmed occluded pixels on said display using a predetermined display value.

2. The method of claim 1, wherein said step of analyzing said first contents to identify said first set of potentially occluded pixels further comprises the step of
comparing a value of each pixel of said first contents to a corresponding value of each pixel of said image.

3. The method of claim 2, wherein said display values represent one of a color and an intensity.

4. The method of claim 1, wherein said step of changing a value further comprises the step of:
changing said value of said first set of potentially occluded pixels to a reserved value; and
regenerating said display using said reserved value for said first set of potentially occluded pixels and image values for remaining pixels.

5. The method of claim 1 further comprising the step of:
identifying display pixels within a predetermined distance of said confirmed occluded pixels as a second set of potentially occluded pixels;
changing a value of said second set of potentially occluded pixels on said display to a reserved value;
capturing third contents of said display using said image capture device; and
selectively confirming said second set of potentially occluded pixels as confirmed occluded pixels based on said third contents.

6. The method of claim 6, wherein said predetermined distance is user selectable.

7. A method for processing a displayed image comprising the steps of:
passively testing a version of said displayed image captured by an image capture device to determine if a portion of said displayed image is blocked from said image capture device; and
actively testing said portion of said displayed image to confirm whether said portion of said displayed image is blocked from said image capture device.

8. The method of claim 7, wherein said step of passively testing further comprises the step of:
comparing a value of each pixel of said version of said displayed image captured by said image capture device to a corresponding value of each pixel of said displayed image.

9. The method of claim 7, wherein said step of actively testing further comprises the steps of:
changing a display value of said portion of said displayed image;
capturing another version of said displayed image with said image capture device; and
selectively confirming said portion of said displayed image as occluded based on an analysis of said another version.

10. The method of claim 9, wherein said step of actively testing further comprises the step of:
testing another portion of said displayed image proximate said confirmed portion of said displayed image for occlusion.

11. The method of claim 7, further comprising the step of:
actively testing all of the pixels of said displayed image, prior to said step of passively testing, to initialize an estimate of said displayed image.

12. The method of claim 7, further comprising the step of:
changing a threshold associated with said step of passively testing said version of said displayed image, based upon a result of said step of actively said portion of said displayed image.

13. A computer-readable medium containing a program that performs the steps of:
passively testing a version of a displayed image captured by an image capture device to determine if a portion of said displayed image is blocked from said image capture device; and
actively testing said portion of said displayed image to confirm whether said portion of said displayed image is blocked from said image capture device.

14. The computer-readable medium of claim 13, wherein said step of passively testing further comprises the step of:
comparing a value of each pixel of said version of said displayed image captured by said image capture device to a corresponding value of each pixel of said displayed image.

15. The computer-readable medium of claim 13 wherein said step of actively testing further comprises the steps of:
changing a display value of said portion of said displayed image;
capturing another version of said displayed image with said image capture device; and
selectively confirming said portion of said displayed image as occluded based on an analysis of said another version.

16. The computer-readable medium of claim 15, wherein said step of actively testing further comprises the step of:
testing another portion of said displayed image proximate said confirmed portion of said displayed image for occlusion.

17. The computer-readable medium of claim 13, further comprising the step of:
actively testing all of the pixels of said displayed image, prior to said step of passively testing, to initialize an estimate of said displayed image.

18. The computer-readable medium of claim 13, further comprising the step of:
changing a threshold associated with said step of passively testing said version of said displayed image, based upon a result of said step of actively said portion of said displayed image.

19. An image processing system comprising:
a display for displaying said image;
an image capture device for capturing a version of said displayed image; and
a processor, connected to said display and said image capture device for passively testing said version of said displayed image captured by said image capture device to determine if a portion of said displayed image is blocked from said image capture device; and for actively testing said portion of said displayed image to confirm whether said portion of said displayed image is blocked from said image capture device.

20. The system of claim 19, wherein said processor performs said passive testing by comparing a value of each pixel of said version of said displayed image captured by said image capture device to a corresponding value of each pixel of said displayed image.

21. The system of claim 19 wherein said processor performs said active testing by changing a display value of said portion of said displayed image; capturing another version of said displayed image with said image capture device; and selectively confirming said portion of said displayed image as occluded based on an analysis of said another version.

22. The system of claim 21, wherein said processor performs said active testing by testing another portion of said displayed image proximate said confirmed portion of said displayed image for occlusion.

23. The system of claim 19, wherein said processor also performs active testing prior to said passive testing by actively testing all of the pixels of said displayed image to initialize an estimate of said displayed image.

24. The system of claim 19, wherein said processor also changes a threshold associated with said step of passively testing said version of said displayed image, based upon a result of said step of actively said portion of said displayed image.

25. An image processing system comprising:
means for displaying said image;
means for capturing a version of said displayed image; and
means, connected to said means for displaying and said means for capturing, for passively testing said version of said displayed image captured by said image capture device to determine if a portion of said displayed image is blocked from said image capture device and for actively testing said portion of said displayed image to confirm whether said portion of said displayed image is blocked from said image capture device.
